(19) United States
(12) Patent Application Publication
(10) Pub. No.: US 2025/0330670 A1
(43) Pub. Date: Oct. 23, 2025

(54) DATA FLOW METERING ON A FIXED RATE LINK INTERFACE

(71) Applicant: Intel Corporation, Santa Clara, CA (US)

(72) Inventors: Daren James Schmidt, Chandler, AZ (US); Nausheen Ansari, Folsom, CA (US); Arthur Jeremy Runyan, Folsom, CA (US)

(73) Assignee: Intel Corporation, Santa Clara, CA (US)

(21) Appl. No.: 19/252,045

(22) Filed: Jun. 27, 2025

(51) Int. Cl. H04N 21/4363

(52) U.S. Cl. CPC H04N 21/43635

(57) ABSTRACT

Example systems, apparatus, articles of manufacture, and methods to perform data flow metering on a fixed rate link interface are disclosed. An example apparatus disclosed herein increments a first pointer to track a first number of data characters to be written to a fixed rate link interface in a clock period of the fixed rate link interface, the fixed rate link associated with a first clock frequency. The example apparatus also increments a second pointer to track a second number of data characters to be read from the fixed rate link interface in the clock period, the second pointer incremented based on integer and fractional components of a ratio between a second clock frequency and the first clock frequency, the second clock frequency associated with a data source. The example apparatus further meters data transmission on the fixed rate link interface based on the first pointer and the second pointer.

### BACKGROUND

Fixed rate link interfaces communicate data over a communication link operating at a constant, or discrete, data rate. Some fixed rate link interfaces can be configured to communicate data at a particular constant data rate selected from a set of possible constant data rates. However, the particular constant data rate used to communicate data over the fixed rate data interface may be different from the source data rate of the source traffic to be communicated over communication link.

### BRIEF DESCRIPTION OF THE DRAWINGS

FIG. 1 is a block diagram of a first example system including a first example source device that implements data flow metering on an example fixed rate link interface.

FIG. 2 illustrates an example of data flow metering on an example fixed rate link interface.

FIG. 3 is a block diagram of a second example system including a second example source device that implements data flow metering on an example fixed rate link interface in accordance with teachings of this disclosure.

FIG. 4 illustrates an example virtual data flow metering buffer utilized by the second example source device of FIG. 3 to perform data flow metering.

FIGS. 5-8 illustrate example data flow metering operations performed by the second example source device of FIG. 3 based on the virtual data flow metering buffer of FIG. 4

FIGS. 9-10 are flowcharts representative of example machine readable instructions and/or example operations that may be executed, instantiated, and/or performed by example programmable circuitry to implement the source device of FIG. 3.

FIG. 11 is a block diagram of an example processing platform including programmable circuitry structured to execute, instantiate, and/or perform the example machine readable instructions and/or perform the example operations of FIGS. 9-10 to implement the source device of FIG. 3.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 9-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

A fixed rate link (FRL) interface communicates data over a communication link, such as a cable, a bus, a channel, etc., at a constant data rate. In some systems, the particular constant data rate used by the FRL interface to communicate data is selectable or otherwise configurable from a set of possible constant data rates. For instance, the high-definition multimedia interface (HDMI)® specification, version 2.1b, 2023, defines an FRL interface, also referred to as an FRL mode, in which data is communicated over an HDMI cable at one of four possible constant data rates, such as 3 Gigabits/sec (Gb/s), 6 Gb/s, 8 Gb/s or 12 Gb/s.

However, in at least some systems employing FRL interfaces, the source traffic to be communicated over the communication link may have a source data rate that is different than (e.g., lower than) the particular constant data rate of the FRL interface. In some such systems, data flow metering may be employed to allow source traffic at the source data rate to be communicated over the FRL interface at the particular constant data rate. Such data flow metering may involve regulating the starting and stopping of the source traffic, along with inserting fill data (e.g., such as gap characters, null characters, etc.) when the source traffic is stopped, to achieve an effective traffic throughput corresponding to the source data rate even though the actual traffic communicated over the RFL interface is at the interface's constant data rate.

In the HDMI FRL mode of operation, the source device may be expected to meter the video and audio source data it transmits to the sink device when the link data rate (or, in other words, the link bandwidth) is greater than the source data rate for the particular resolution of the source video. To implement such metering, the HDMI® 2.1 specification assumes source devices and sink devices will incorporate physical buffers to accommodate metering of the data traffic over the FRL interface. This assumption implies that the HDMI source device is generating source data based on a pixel clock frequency and a data buffer will be used to clock cross the video and audio data to the fixed rate clock domain of the FRL interface. In some instances, to achieve such operation, the source device would require a relatively large physical data buffer to provide clock crossing data buffering, as well as at least two phase-locked loops (PLLs) to generate the asynchronous pixel clock and FRL clock.

In contrast, example data flow metering (DFM) techniques disclosed herein implement DFM on an FRL interface without a physical clock crossing buffer or other data structure, and without a second PLL to track both the pixel clock and the FRL clock. In some example DFM techniques disclosed herein for HDMI systems, the HDMI transport layer circuitry is modified to operate within a single, pre-serialized FRL clock domain that is based on the FRL character clock, which is a 1/18 divided clock from the PLL used for the HDMI FRL interface. Furthermore, the disclosed example HDMI transport layer circuitry maintains two virtual pointers to a virtual data buffer. In some disclosed examples, the HDMI transport layer circuitry increments (or adjusts) a virtual write pointer as video and audio data is transmitted to the sink device. In some disclosed examples, the HDMI transport layer circuitry also increments (or adjusts) a virtual read pointer continuously based on an emulated pixel clock frequency derived from the FRL character clock (rather than utilizing a separate PLL to generate the pixel clock). In some examples, the emulated pixel clock that controls the virtual read pointer movement is generated by a programmable digital difference accumulator (DDA). In some disclosed examples, the HDMI transport layer circuitry controls data flow metering using the separation of these two virtual pointers to determine when and how much video and/or audio data can be transmitted to the sink device over the FRL interface during a given FRL clock period.

As such, example DFM techniques disclosed herein can simplify the source device by removing the need to maintain two separate PLLs per HDMI port, and/or by removing the need for a physical DFM data buffer per HDMI port. Disclosed example DFM techniques also provide a configurable and scalable DFM solution that can seamlessly adapt to changes in traffic patterns being sent from the source device to the sink device.

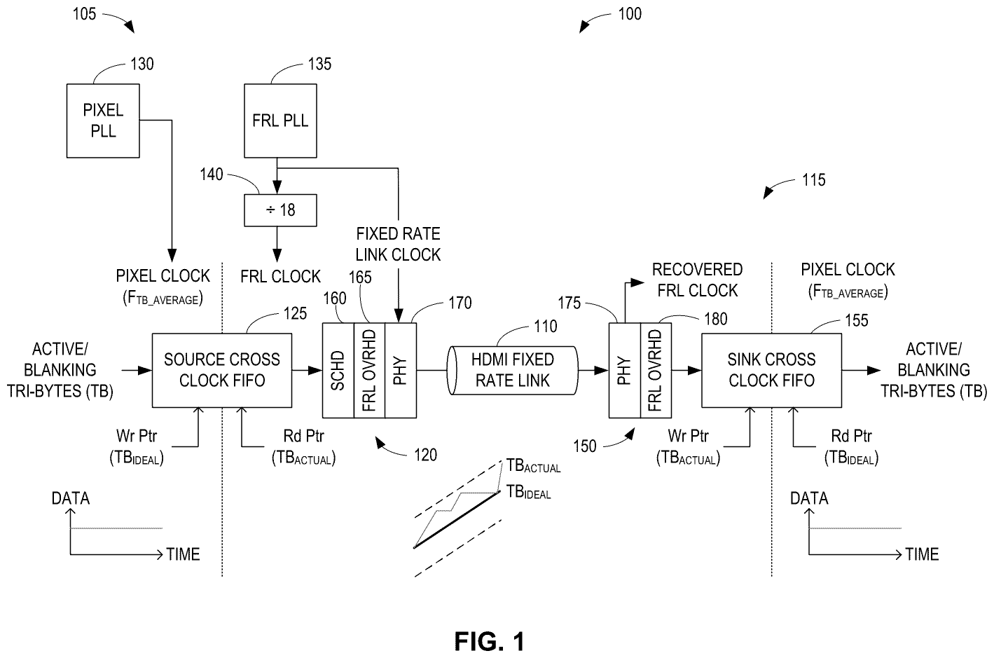

FIG. 1 is a block diagram of a first example system 100 including a first example source device 105 that implements data flow metering on an example fixed rate link interface 110. In the illustrated example of FIG. 1, the fixed rate link interface 110 is an HDMI FRL interface 110, and the source device 105 generates and transmits source video and audio data, which is referred to collectively as source media data, to an example sink device 115 over the HDMI FRL interface 110. As such, the source device 105 of the illustrated example can be any media source device, such as, for example, a streaming media player, a digital cable box, a digital satellite box, a video game console, digital versatile disk (DVD) player, etc. The sink device 115 of the illustrated example can be any media sink device, such as, for example, a television, a monitor, a projector, etc.

The block diagram of FIG. 1 illustrates example components of the source device 105 that are related to data flow metering over the HDMI FRL interface 110. For example, the source device 105 of FIG. 1 includes example HDMI source transport layer circuitry 120, an example source cross clock buffer 125, an example pixel clock PLL 130, an example FRL clock PLL 135 and an example FRL clock divider 140. The block diagram of FIG. 1 also illustrates example components of the sink device 115 that are related to data flow metering over the HDMI FRL interface 110. For example, the sink device 115 of the FIG. 1 includes example HDMI sink transport layer circuitry 150 and an example sink cross clock buffer 155.

In the illustrated example of FIG. 1, the source device 105 utilizes data flow metering (DFM) to meter or, in other words, regulate the transmission of video data (e.g., including active video data and blanking data) over the HDMI FRL interface 110 to the sink device 115. In some examples, other HDMI data types, such as map characters (e.g., gap and/or packet map characters), super block special characters, Reed-Solomon characters, etc., that the source device 105 transmits to the sink device 115 do not partake in the data flow metering.

In the illustrated example of FIG. 1, the HDMI source transport layer circuitry 120 implements DFM at the source device 105 based, at least in part, on (i) an ideal tri-byte rate (TB_{ideal}) of the source data (e.g., the active video data, blanking data, etc.) generated by the source device 105 and (ii) an actual tri-byte rate (TB_{actual}) corresponding to the actual, or effective, rate of transmission of tri-bytes over the HDMI FRL interface 110 to the sink device 115. In the context of HDMI, a tri-byte refers to a unit of data used to represent a given video pixel. A tri-byte includes three (3) bytes of information corresponding respectively to the three (3) color components used to represent a pixel (e.g., such as red, green and blue color components used to represent the pixel). The ideal tri-byte rate (TB_{ideal}) is based on the pixel clock frequency, f_{TB,Average}, that the source device 105 uses to generate and the blanking and active video tri-bytes to achieve the configured resolution of video being provided to the sink device 115. The ideal tri-byte rate TB_{ideal}, therefore, has a constant slope corresponding to the number of blanking and active video tri-bytes generated over time based on the pixel clock frequency, f_{TB,Average}.

The actual tri-byte rate (TB_{actual}) is the rate at which the source device 105 is able to transmit the blanking and active tri-bytes within the FRL character clock domain. In the context of HDMI FRL mode, an FRL character is a unit of data that includes two (2) bytes or, equivalently, sixteen (16) bits of data, as well as two additional bits related to FRL operation. Thus, to transmit data over the HDMI FRL interface 110, the HDMI source transport layer circuitry 120 maps the source tri-byte data into FRL characters. This mapping can be represented as different weights that correspond to the amount of blanking or active video tri-byte data a given FRL character over the HDMI FRL interface 110. The different weights, therefore, affect the slope of actual tri-byte rate (TB_{actual}) over the HDMI FRL interface 110. Table 1 illustrates example weights corresponding to different FRL characters that carry different types of source data.

TABLE 1

| FRL Character | Weight |
|---|---|
| Blanking Control Period | RC + 1 |
| Blanking Data/Island Guard Band Data | 1 |
| Active Video | 2/3 or 1/3 |
| Map, Super Block, Reed-Solomon | 0 |

In Table 1, an FRL character that carries active video data can carry at most two bytes of an active tri-byte, which corresponds to a weight of ⅔ (e.g., corresponding to carrying two of the three bytes in a tri-byte). For active lines that utilize zero padding, the last FRL character of the line may carry one byte of an active tri-byte, which corresponds to a weight of ⅓ (e.g., corresponding to carrying one of the three bytes in a tri-byte). In Table 1, an FRL character that carries blanking control period data has a weight based on a repeat count (RC) that can vary from 0 to 7, which corresponds to the FRL character being able to carry from 1 to 8 tri-bytes of blanking control period data based on the amount of compression applied to the blanking control period data. In Table 1, an FRL character that carries other blanking data and/or island guard band data has a weight of 1, which corresponds to the FRL character being able to carry 1 tri-byte of the other blanking data and/or island guard band data. In Table 1, an FRL character that carries map data, super block data, Reed-Solomon data, etc., has a weight of 0 because those characters are not subject to data flow metering, as described above.

In the illustrated example, the FRL clock PLL 135 provides an FRL clock that corresponds to the constant bit rate of the HDMI FRL interface 110. The HDMI source transport layer circuitry 120 causes the FRL characters to be transmitted from the source device 105 over the HDMI FRL interface 110 at an FRL character clock rate (f_{FRL Char clock}), which is a 1/18 divided clock (due to each FRL character including 18 bits) obtained by dividing the FRL clock PLL 135 with the FRL clock divider 140. Due to the different weightings of the FRL characters being transmitted over the HDMI FRL interface 110 at the fixed link frequency, the actual (e.g., effective) rate of tri-byte data (TB_{actual}) transmitted over the HDMI FRL interface 110 varies over time depending on the type of data being carried by the FRL characters being transmitted. As such, the ideal tri-byte rate TB_{ideal} and the actual tri-byte rate TB_{actual} may be different from each other. The difference between the two rates is referred to as TB_{difference}, which is given by

$${TB}_{difference} = {TB}_{actual} - {TB}_{ideal} \qquad Equation 1$$

In some examples, the source device 105 is allowed a maximum difference of TB_{difference,Max}=492 tri-bytes above or below TB_{ideal}, which yields a permitted difference of:

$$\vert {TB}_{difference} \vert \leq 492 tri - bytes = {TB}_{difference , Max} \qquad Equation 2$$

In some examples, a different maximum difference, TB_{difference,Max}, is permitted.

In the illustrated example of FIG. 1, the HDMI source transport layer circuitry 120 implements DFM to maintain the difference, TB_{difference}, between the actual (e.g., effective) tri-byte rate, TB_{actual}, of tri-byte data transmitted over the HDMI FRL interface 110 and the ideal tri-byte rate, TB_{ideal}, of data generated by the source device 105 within the allowed maximum difference, TB_{difference}, Max. For example, the HDMI source transport layer circuitry 120 includes example scheduler circuitry 160, example FRL overhead circuitry 165 and example physical interface circuitry 170 to cause source data generated by the source device 105 to be transmitted over the FRL interface 110 using DFM. In the illustrated example, the scheduler circuitry 160 operates to meter, or regulate, the data flow of FRL characters containing source data (e.g., active video data, blanking data, etc.) over the FRL interface 110 to maintain the difference, TB_{difference}, between the actual (e.g., effective) tri-byte rate, TB_{actual}, of tri-byte data transmitted over the FRL interface 110 and the ideal tri-byte rate, TB_{ideal}, of data generated by the source device 105 within the allowed maximum difference, TB_{difference,Max}. For example, the scheduler circuitry 160 may meter, or regulate, the data flow of FRL characters by starting (e.g., resuming) and stopping (e.g., pausing) transmission of FRL characters containing source data to cause the difference, TB_{difference}, between the actual (e.g., effective) tri-byte rate, TB_{actual}, and the ideal tri-byte rate, TB_{ideal}, in a given clock period of the FRL interface 110 to satisfy Equation 2.

In the illustrated example, the scheduler circuitry 160 invokes or otherwise uses the FRL overhead circuitry 165 to cause fill data (e.g., such a gap characters, null characters, etc.) to be inserted in the data flow being transmitted over the FRL interface 110 while the scheduler circuitry 160 has stopped (e.g., paused) transmission of the FRL characters containing source data (e.g., active video data, blanking data, etc.) in the context of DFM. The FRL overhead circuitry 165 inserts such fill data to maintain the constant data rate of the FRL interface 110. In the illustrated example, the physical interface circuitry 170 interfaces with the FRL interface 110 and writes data to the FRL interface 110 for transmission to the sink device 115. For example, the physical interface circuitry 170 may include an HDMI port and associated circuitry to couple to an HDMI cable providing the FRL interface 110 and write FRL characters containing source data, fill data and/or other FRL data to the FRL interface 110 at the constant FRL character clock rate (f_{FRL Char clock}).

In the illustrated example of FIG. 1, the HDMI source transport layer circuitry 120 also utilizes the source cross clock buffer 125 to implement DFM over the FRL interface 110. The source cross clock buffer 125 is structed to allow data to be written into the buffer based on a first clock corresponding to a first clock domain, and to be read from the buffer based on a second clock corresponding to a different, second clock domain, thereby supporting clock crossing of the data between the two clock domains. In some examples, the source cross clock buffer 125 is a first-in first-out (FIFO) buffer with a depth, or size, in tri-bytes of at least twice TB_{difference}, max (e.g., 2*TB_{difference},max) to support the DFM limits specified by Equation 2. In the illustrated example, the source device 105 writes source data to the source cross clock buffer 125 at the ideal tri-byte rate, TB_{ideal}, based on the pixel clock, f_{TB,Average}, generated by the pixel clock PLL 130. The source cross clock buffer 125 has a write pointer that points to the current location at which source data is to be written to the source cross clock buffer 125, and the write pointer is, therefore, incremented at the ideal tri-byte rate, TB_{ideal}. In the illustrated example, the HDMI source transport layer circuitry 120 reads the source data out of the source cross clock buffer 125 at the actual tri-byte rate, TB_{actual}, based on the FRL character clock, f_{FRL Char clock}, generated by the FRL clock PLL 135 and the FRL clock divider 140. The source cross clock buffer 125 has a read pointer that points to the current location at which source data is to be read from the source cross clock buffer 125, and the read pointer is, therefore, incremented at actual tri-byte rate, TB_{actual}. As described above, the FRL character clock, f_{FRL Char clock}, and the pixel clock, f_{TB,Average}, are asynchronous clocks and, thus, the difference between the write pointer and the read pointer of the source cross clock buffer 125 varies over time. Furthermore, because the write pointer corresponds to the ideal tri-byte rate, TB_{ideal}, and the read pointer corresponds to the actual tri-byte rate, TB_{actual}, the difference between the read pointer and the write pointer of the source cross clock buffer 125 corresponds to the difference, TB_{difference}, between the actual tri-byte rate, TB_{actual}, and the ideal tri-byte rate, TB_{ideal}, which is given by Equation 1.

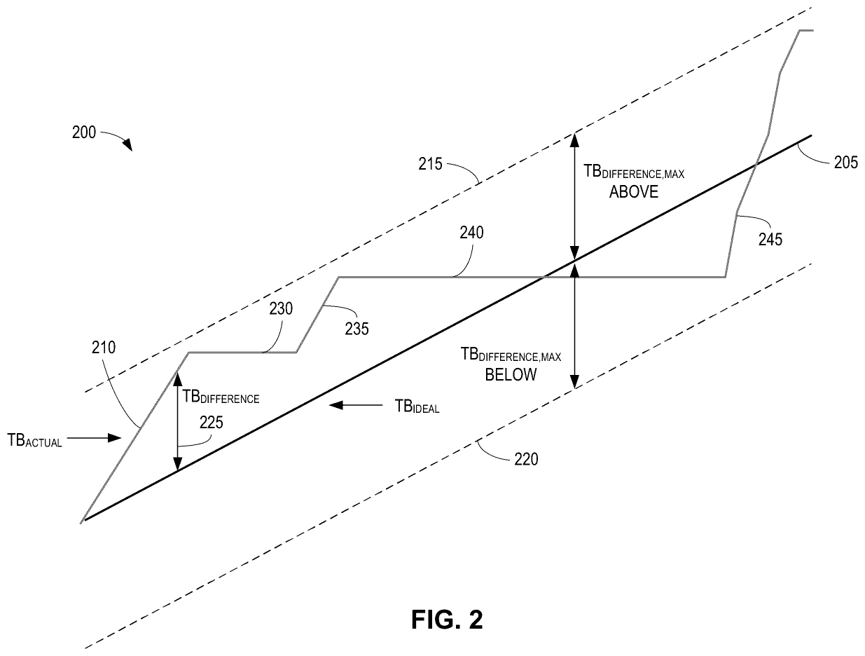

Thus, in the illustrated example, the HDMI source transport layer circuitry 120 uses the difference between the read pointer and the write pointer of the source cross clock buffer 125 to perform DFM over the FRL interface 110. An example DFM procedure 200 performed by the HDMI source transport layer circuitry 120 of the source device 105 over the FRL interface 110 is illustrated in FIG. 2. In the example DFM procedure 200 of FIG. 2, the source device 105 generates and writes source data tri-bytes to the source cross clock buffer 125 at the ideal tri-byte rate, TB_{ideal}, which is represented by the line 205 in FIG. 2. In the DFM example 200 of FIG. 2, the HDMI source transport layer circuitry 120 begins reading source data tri-bytes from the source cross clock buffer 125 for transmission on the FRL interface 110 at the actual tri-byte rate, TB_{actual}, which is represented by the line segment 210 in FIG. 2. As shown in FIG. 2, the line segment 210 has a larger slope than the line 205 because the FRL interface 110 clock rate is such that the actual tri-byte rate, TB_{actual}, is higher than the ideal tri-byte rate, TB_{ideal}. In the DFM example 200 of FIG. 2, the HDMI source transport layer circuitry 120 meters, or regulates, transmission of FRL characters containing source data tri-bytes such that the difference, TB_{difference}, between the actual tri-byte rate, TB_{actual}, and the ideal tri-byte rate, TB_{ideal}, is maintained within the maximum difference, TB_{difference,Max}, specified by Equation 2, which corresponds to the dashed lines 215 and 220 in FIG. 2.

For example, the HDMI source transport layer circuitry 120 computes the difference between the read pointer and the write pointer of the source cross clock buffer 125 to track the difference, TB_{difference}, between the actual tri-byte rate, TB_{actual}, and the ideal tri-byte rate, which is represented by the line 225 in FIG. 2. When the difference, TB_{difference}, between the actual tri-byte rate, TB_{actual}, and the ideal tri-byte rate, is close to the maximum difference, TB_{difference,Max}, such as within a threshold, the HDMI source transport layer circuitry 120 stops (e.g., pauses) transmission of FRL characters containing source data tri-bytes on the FRL interface 110, which is represented by the line segment 230 in FIG. 2. While transmission of source tri-byte FRL characters is paused, the HDMI source transport layer circuitry 120 causes fill data (e.g., such a gap characters, null characters, etc.) to be transmitted on the FRL interface 110. When the difference, TB_{difference}, between the actual tri-byte rate, TB_{actual}, and the ideal tri-byte rate, is sufficiently below the maximum difference, TB_{difference,Max}, such as below another threshold, the HDMI source transport layer circuitry 120 starts (e.g., resumes) transmission of FRL characters containing source data tri-bytes on the FRL interface 110, which is represented by the line segment 235 in FIG. 2.

The foregoing example DFM procedure 200 then continues while there are source data tri-bytes to be transmitted over the FRL interface 110, which is represented by the line segments 240 and 245. In some examples, after the HDMI source transport layer circuitry 120 stops (e.g., pauses) transmission of FRL characters containing source data tri-bytes on the FRL interface 110, the HDMI source transport layer circuitry 120 may wait to start (e.g., resume) transmission of FRL characters containing source data tri-bytes until the read and write buffers of the source cross clock buffer 125 are close to (e.g., within a threshold of) the lower bound of the maximum difference, TB_{difference,Max}, which corresponds to the transition between line segments 240 and 245 in FIG. 2.

Returning to FIG. 1, the sink device 115 includes the HDMI sink transport layer circuitry 150 and the sink cross clock buffer 155 to recover the source data tri-byes from the FRL characters received over the FRL interface 110. The HDMI sink transport layer circuitry 150 of the illustrated example includes example physical interface circuitry 175 and example FRL overhead circuitry 180. The physical interface circuitry 175 may include an HDMI port and associated circuitry to couple to an HDMI cable providing the FRL interface 110 and read FRL characters containing source data, fill data and/or other FRL data from the FRL interface 110 at the constant FRL character clock rate (f_{FRL Char clock}). The FRL overhead circuitry 180 removes fill data (e.g., such a gap characters, null characters, etc.) from the data flow of FRL characters from the physical interface circuitry 175 and writes the remaining FRL characters containing source data (e.g., active video data, blanking data, etc.) to the sink cross clock buffer 155 using a write pointer that increments at the actual (e.g., effective) tri-byte rate, TB_{actual}. The sink device 115 is then able to read source data tri-bytes from the sink cross clock buffer 155 using a read pointer that increments at the ideal tri-byte rate, TB_{ideal}.

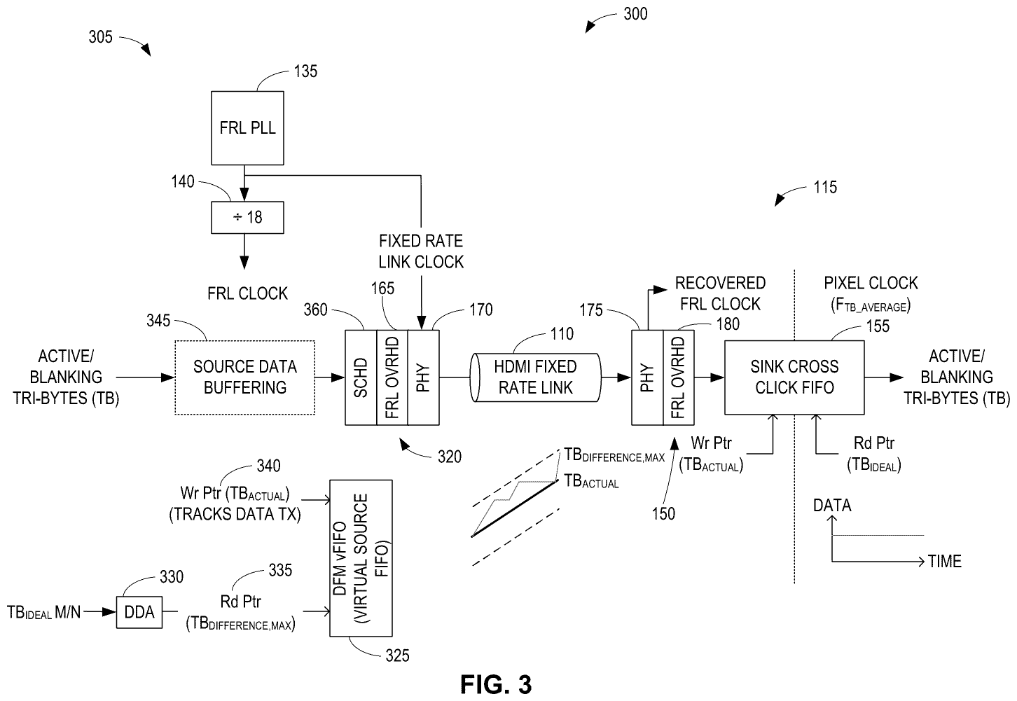

FIG. 3 is a block diagram of a second example system 300 including a second example source device 305 that implements data flow metering on the example fixed rate link interface 110. The source device 305 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the source device 305 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example system 300 of FIG. 3 includes the FRL interface 110 and the sink device 115 of the example system 100 of FIG. 1. Accordingly, the descriptions of the FRL interface 110 and the sink device 115 are provided above in the context of the description of FIG. 1 and are not reproduced in the description of FIG. 3. The example source device 305 of FIG. 3 also includes the FRL clock PLL 135 and the FRL clock divider 140 of the example system 100 of FIG. 1. Accordingly, the descriptions of the FRL clock PLL 135 and the FRL clock divider 140 are provided above in the context of the description of FIG. 1 and are not reproduced in the description of FIG. 3.

The example source device 305 of FIG. 3 also includes example HDMI source transport layer circuitry 320 to implement DFM over the FRL interface 110. However, in contrast with the source device 105 of FIG. 1, the source device 305 of FIG. 3 omits the source cross clock buffer 125 and the separate pixel clock PLL 130. Instead of including the source cross clock buffer 125 and the separate pixel clock PLL 130, the source device 305 maintains an example virtual data structure 325 that emulates the source cross clock buffer 125 to perform data flow metering. The virtual data structure 325 is also referred to as a virtual source buffer 325, a virtual source FIFO 325, etc. However, unlike the physical source cross clock buffer 125 in the source device 105, the virtual source buffer 325 in the source device 305 operates in the single clock domain of the FRL character clock, f_{FRL Char clock}, generated by the FRL clock PLL 135 and the FRL clock divider 140, thereby allowing the separate pixel clock PLL 130 to be omitted.

In the illustrated example of FIG. 3, the virtual source buffer 325 is implemented by an example programmable digital difference accumulator (DDA) 330 included in the source device 305 to emulate the pixel clock, f_{TB,Average}. The virtual source buffer 325 is also implemented by an example virtual read pointer 335 and an example virtual write pointer 340 that are maintained by the HDMI source transport layer circuitry 320 (e.g., by example scheduler circuitry 360 included in the HDMI source transport layer circuitry 320) using the DDA 330. In some examples, the DDA 330 controls the virtual read pointer 335 independently, possibly after configuration by the HDMI source transport layer circuitry 320 (e.g., by the scheduler circuitry 360). In the illustrated example, the virtual write pointer 340 of the virtual source buffer 325 tracks the actual amount of source data tri-bytes the source device 105 has transmitted over the FRL interface 110 at the actual (e.g., effective) tri-byte rate, TB_{actual}. The virtual read pointer 335 tracks the amount of source data tri-bytes read from the FRL interface 110 by the sink device 115 at the ideal tri-byte rate (TB_{ideal}). Depending on how the virtual read pointer 335 is initialized, the virtual read pointer 335 may also track the point in the virtual source buffer 325 that corresponds to the upper bound, TB_{difference,Max}, on the amount of source data tri-bytes the source device 105 is permitted to transmit over the FRL interface 110 in the current clock period.

The source device 305 of FIG. 3 also includes an example source data buffer 345 to temporarily store source data tri-bytes (e.g., active video data, blanking data, etc.) before transmission over the FRL interface 110. However, in the illustrated examples, source data buffer 345 has a smaller size than the source cross clock buffer 125 included in the source device 105 of FIG. 1.

In the illustrated example of FIG. 3, the DDA 330 operates to emulate the pixel clock, f_{TB,Average}, in the domain of the FRL character clock, f_{FRL Char clock}. In the illustrated example, the DDA 330 performs such emulation based on a ratio between the pixel clock, f_{TB,Average}, corresponding to the current video resolution and the FRL character clock, f_{FRL Char clock}. In some examples, the DDA tracks the fractional portion of that ratio and identifies trip events corresponding to when the accumulated fraction increments past a value of 1.0.

In some examples, the DDA 330 operates as follows. First, the HDMI source transport layer circuitry 320 (e.g., with its scheduler circuitry 360) and/or a software driver, etc., computes parameters used by the DDA 330. For example, the HDMI source transport layer circuitry 320 computes the ratio between the pixel clock, f_{TB,Average}, corresponding to the current video resolution and the FRL character clock, f_{FRL Char clock}. For example, the HDMI source transport layer circuitry 320 may compute this ratio, represented by TB_{ideal} M/N, according to Equation 3:

$${TB}_{ideal} M / N = {f}_{TB , Average} / {f}_{FRL Char clock} \qquad Equation 3$$

The HDMI source transport layer circuitry 320 and/or a software driver, etc., then computes a numerator integer value, represented by TB_{ideal} M, and a denominator integer value, represented by TB_{ideal} N, whose ratio is equals (e.g., is the same as) the ratio, TB_{ideal} M/N, between the pixel clock, f_{TB,Average}, corresponding to the current video resolution and the FRL character clock, f_{FRL Char clock} given by Equation 3. For example, the HDMI source transport layer circuitry 320 may compute the numerator integer value, TB_{ideal} M, and the denominator integer value TB_{ideal} N, according to Equation 4:

$$\begin{matrix}{TB}_{ideal} M = {f}_{TB , Average} / GCD \\ {TB}_{ideal} N = {f}_{FRL Char clock} / GCD\end{matrix} \qquad Equation 4$$

In Equation 4, GCD is the greatest common denominator between f_{TB,Average} and f_{FRL Char clock}.

The HDMI source transport layer circuitry 320 and/or a software driver, etc., then uses the numerator integer value, TB_{ideal} M, and the denominator integer value, TB_{ideal} N, to separate the ratio, TB_{ideal} M/N, into an integer component, represented by TB_{ideal} Ratio_{integer}, and a fractional component, represented by TB_{ideal} Ratio_{fraction}. For example, the HDMI source transport layer circuitry 320 may compute the integer component, TB ideal Ratio_{integer}, and the fractional component, TB_{ideal} Ratio_{fraction}, according to Equation 5:

$$\begin{matrix}{TB}_{ideal} {Ratio}_{integer} = INT ( {TB}_{ideal} M / {TB}_{ideal} N ) \\ {TB}_{ideal} {Ratio}_{fraction} = MOD ( {TB}_{ideal} M , {TB}_{ideal} N )\end{matrix} \qquad Equation 5$$

In Equation 5, INT( ) represents the integer operation, and MOD( ) represents the modulo operation.

After computing the preceding parameters, the HDMI source transport layer circuitry 320 and/or a software driver, etc., initializes the value of the DDA 330. The value of the DDA 330 is represented by TB_{ideal} DDA. For example, the HDMI source transport layer circuitry 320 may initialize the value, TB_{ideal} DDA, of the DDA 330 to be the denominator integer value, TB_{ideal} N, according to Equation 6:

$$The {TB}_{ideal} DDA = {TB}_{ideal} N \qquad Equation 6$$

In the illustrated example, after being initialized, the DDA 330 operates to increment (or adjust) its output value, TB_{ideal} DDA, to a next value, represented by Next TB_{ideal} DDA, based on the current value of the DDA 330, represented by Current TB_{ideal} DDA, and the fractional component, TB_{ideal} Ratio_{fraction}. For example, the DDA 330 may implement the following incrementing algorithm to increment (or adjust) its value at each clock period of the FRL character clock, f_{FRL Char clock}. If the current value of the DDA 330, Current TB_{ideal} DDA, for a given clock period is greater than the denominator value, TB_{ideal} N, then the DDA 330 increments (or adjusts) the next value of the DDA 330, Next TB_{ideal} DDA, relative to the current value of the DDA 330, Current TB_{ideal} DDA, by a difference between the fractional component, TB_{ideal} Ratio_{fraction}, and the denominator value, TB_{ideal} N. Under this condition, the DDA 330 also sets a trip flag, represented by DDA Trip, to a value of 1 (or some other first binary value) to indicate a trip event has occurred. However, if the current value of the DDA 330, Current TB_{ideal} DDA, for the given clock period is not greater than (e.g., is less than or equal to) the denominator value, TB_{ideal} N, then the DDA 330 increments (or adjusts) the next value of the DDA 330, Next TB_{ideal} DDA, relative to the current value of the DDA 330, Current TB_{ideal} DDA, by the fractional component, TB_{ideal} Ratio_{fraction}. Under this condition, the DDA 330 also sets the trip flag, DDA Trip, to a value of 0 (or some other second binary value) to indicate a trip event has not occurred. The preceding incrementing algorithm is shown mathematically in Table 2.

```
TABLE 2
If Current TB_{ideal} DDA > TB_{ideal} N:
  Next TB_{ideal} DDA = TB_{ideal} Ratio_{fraction} + (Current TB_{ideal} DDA − TB_{ideal} N)
  DDA Trip = 1
Else
  Next TB_{ideal} DDA = TB_{ideal} Ratio_{fraction} + Current TB_{ideal} DDA
  DDA Trip = 0
```

In the illustrated example, the HDMI source transport layer circuitry 320 (e.g., with its scheduler circuitry 360) manages the virtual read pointer 335 of the virtual source buffer 325 using the DDA 330 as follows. As described above, the virtual read pointer 335 tracks the amount of source data tri-bytes read from the FRL interface 110 by the sink device 115 at ideal tri-byte rate (TB_{ideal}). Depending on how the virtual read pointer 335 is initialized, the virtual read pointer may also track the point in the virtual source buffer 325 that corresponds to the upper bound, TB_{difference}, Max, on the amount of source data tri-bytes the source device 105 is permitted to transmit over the FRL interface 110 in the current clock period. As such, the virtual read pointer 335 moves at the ideal tri-byte rate (TB_{ideal}) based on the pixel clock frequency, f_{TB,Average}. However, the HDMI source transport layer circuitry 320 actually moves the virtual read pointer 335 based in the FRL clock domain based on the FRL character clock, f_{FRL Char clock}. Thus, in the illustrated examples, the HDMI source transport layer circuitry 320 increments (or adjusts) the virtual read pointer 335 of the virtual source buffer 325 based on the TB_{ideal} M/N ratio between the pixel clock, f_{TB,Average}, corresponding to the current video resolution and the FRL character clock, f_{FRL Char clock} given by Equation 3 and the trip flag, DDA Trip, set by the DDA 330. For example, the HDMI source transport layer circuitry 320 may increment (or adjust) the virtual read pointer 335 of the virtual source buffer 325 based on the integer component, TB_{ideal} Ratio_{integer}, of the TB_{ideal} M/N ratio and the trip flag, DDA Trip, according to Equation 7:

$$Next Read Pointer Position = Current Read Pointer Position + {TB}_{ideal} {Ratio}_{integer} + DDA Trip \qquad Equation 7$$

In the illustrated example, the HDMI source transport layer circuitry 320 (e.g., with its scheduler circuitry 360) manages the virtual write pointer 340 of the virtual source buffer 325 as follows. As described above, the virtual write pointer 340 tracks the actual amount of source data tri-bytes the source device 105 has transmitted over the FRL interface 110 at the actual (e.g., effective) tri-byte rate, TB_{actual}. In other words, the virtual write pointer 34 tracks TB_{actual} and is based on the blanking and active video FRL characters being transmitted to the sink device 115. The amount by which the HDMI source transport layer circuitry 320 increments (or adjusts) the virtual write pointer 340 within a given FRL character clock period is based on the following two factors: (1) the weight of a given FRL character being dispatched, as specified in Table 1 above, which transforms the FRL characters to the tri-byte domain, and (2) the number of character lanes configured for FRL link layer operation. In the illustrated example, the amount by which the HDMI source transport layer circuitry 320 increments (or adjusts) the virtual write pointer 340 within a given FRL character clock is the summation of the FRL character weights across the configured FRL character lanes. In some examples, due to the weighting of the active video FRL characters provided in Table 1, the virtual write pointer 340 operates with a fraction.

In the illustrated example, the HDMI source transport layer circuitry 320 (e.g., with its scheduler circuitry 360) manages the sizing and initialization of the virtual read pointer 335 and the virtual write pointer 340 as follows. The HDMI source transport layer circuitry 320 sizes both the virtual read pointer 335 and the virtual write pointer 340 to cover the full range above and below the TB_{ideal} line, which is twice the maximum difference, TB_{difference,Max} (e.g., 2*TB_{difference}, Max). Because TB_{difference,Max} is a non-power of 2 in some examples, the HDMI source transport layer circuitry 320 may size the virtual read pointer 335 and the virtual write pointer 340 according to Equation 8, which results in the virtual source buffer 325 being slightly oversized:

$$Pointer Size = CEIL ( {log}_{2} ( 2 * {TB}_{difference , Max} ) ) \qquad Equation 8$$

As described above, the virtual write pointer 340 may also include an additional fractional portion to track 0, 1, or 2 fractional bytes within a tri-byte.

In some examples, the HDMI source transport layer circuitry 320 controls the starting, or initialization, position of the virtual read pointer 335 at startup with a configuration register. However, in some examples, the default starting, or initialization, position of the virtual read pointer 335 is at the position of the virtual source buffer 325 corresponding to TB_{Difference,Max} tri-bytes (e.g., 492 tri-bytes) above the initial TB_{ideal} line in the virtual source buffer 325 (e.g., which may correspond to the head or inlet of the virtual source buffer 325 at startup).

In some examples, the HDMI source transport layer circuitry 320 controls the starting, or initialization, position of the virtual write pointer 340 at startup to be at a default position corresponding to the head or inlet of the virtual source buffer 325. However, in some examples, the HDMI source transport layer circuitry 320 controls the starting, or initialization, position of the virtual write pointer 340 at startup with a configuration register. For example, the ability to vary the starting position of the virtual write pointer 340 enables the HDMI source transport layer circuitry 320 to support different possible DFM scenarios, such as the borrowing scenarios described in the HDMI® 2.1 specification.

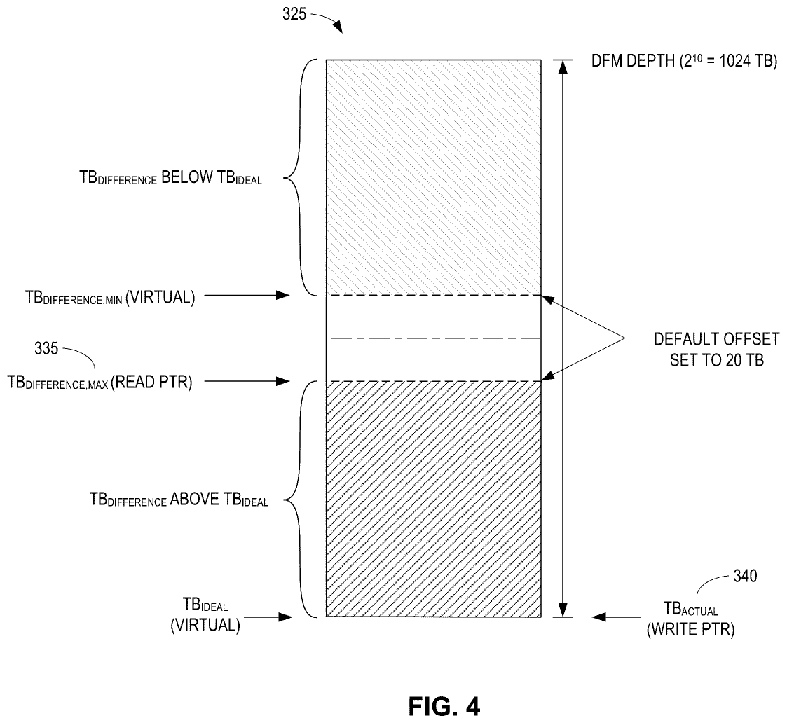

An example initialized configuration of the virtual source buffer 325 of FIG. 3 is illustrated in FIG. 4. In the example of FIG. 4, the HDMI source transport layer circuitry 320 has initialized the virtual read pointer 335 and the virtual write pointer 340 to be at the default positions of the virtual source buffer 325, as described above.

Returning to FIG. 3, the HDMI source transport layer circuitry 320 performs data flow metering for the source device 105 using the virtual source buffer 325 as follows. The scheduler circuitry 360 schedules when to dispatch FRL characters to the FRL interface 110 by performing a resource check against the virtual read pointer 335 and the virtual write pointer 340 of the virtual source buffer 325 to determine how many FRL characters can be dispatched during a current FRL character clock cycle. However, the virtual read pointer 335 and the virtual write pointer 340 operate within the tri-byte (TB) domain, whereas the FRL interface 110 operates in the FRL character domain. Thus, in some examples, the scheduler circuitry 360 determines the amount of TB resources available within the virtual source buffer 325 at any given clock cycle as the difference between the virtual read pointer 335 and the virtual write pointer 340 according to Equation 9:

$$Number TB Resources Available = Virtual Read Pointer - Virtual Write Pointer \qquad Equation 9$$

In some examples, the scheduler circuitry 360 modifies Equation 9 to account for the virtual read pointer 335 and the virtual write pointer 340 wrapping at the end (e.g., top) of the virtual source buffer 325. Also, in some examples, the scheduler circuitry 360 modifies Equation 9 to account for the fractional portion the virtual write pointer 340. Furthermore, in some examples, the scheduler circuitry 360 manages the movement of the virtual read pointer 335 and the virtual write pointer 340 to ensure the virtual read pointer 335 remains ahead of the virtual write pointer 340 in the virtual source buffer 325.

Next, the scheduler circuitry 360 converts the Number TB Resources Available computed according to Equation 9 into the number of FRL characters to be dispatched for the one or more categories of source traffic to be dispatched by the scheduler circuitry 360 for the current clock cycle. Table 3 provides an example of the conversion for three different types of source traffic.

TABLE 3

| Traffic Category | Conversion |
|---|---|
| Number Compressed Blank | FLOOR(INT(Num DFM TB |
| Characters Available | Avail)/8) ^{(1, 2)} |
| Number Un-Compressed Blank | INT(Num DFM TB Avail) ⁽¹⁾ |
| Characters Available | |
| Number Active FRL Characters | ((INT(Num DFM TB Avail) * 3) + |
| Available | FRAC(Num DFM TB Avail))/2 ^{(3, 4)} |

In Table 3, the conversions for blanking characters are pessimistic and round down the result by ignoring any fractional portions (see note 1 in Table 3). In Table 3, the conversion for compressed blanking characters assumes a worst-case weight for the compressed blank characters (e.g., RC=7 in Table 1) (see note 2 in Table 3). In Table 3, the conversion of active video characters involves converting the number of DFM tri-bytes to bytes (e.g., corresponding to the multiplication by 3 in the conversion) and then converting the number of bytes to characters (e.g., corresponding to the division by 2 in the conversion) (see note 3 in Table 3). Also, in Table 3, because the fractional portion of the conversion of active video characters is already in bytes, the multiplication by 3 operation is not performed on the fractional portion (see note 4 in Table 3).

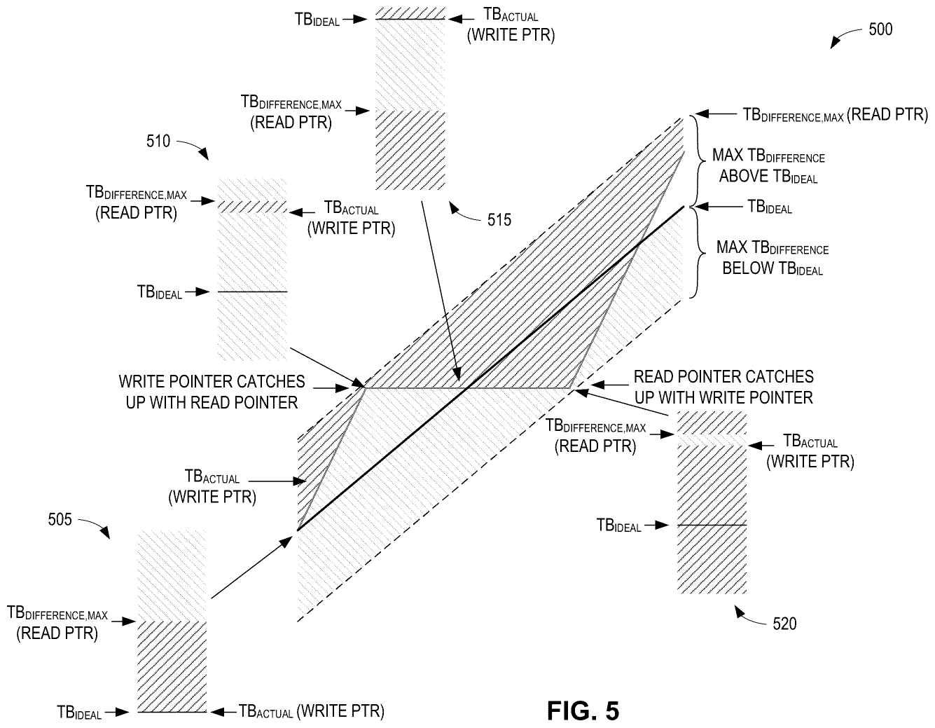

FIG. 5 illustrates an example DFM procedure 500 performed by the HDMI source transport layer circuitry 320 of the source device 305 using the virtual source buffer 325. The DFM procedure 500 shows four different example configurations of the virtual source buffer 325 and four different phases of the DFM procedure 500. In a starting phase of the DFM procedure 500, the HDMI source transport layer circuitry 320 configures the virtual source buffer 325 in an example initialization configuration 505. In a next phase of the DFM procedure 500, which corresponds to a time period after FRL characters have been transmitted by the source device 305 over the FRL interface, the DDA 330 has moved the virtual read pointer 335 and the HDMI source transport layer circuitry 320 has moved the virtual write pointer 340 of the virtual source buffer 325 into a second example configuration 510 corresponding to the virtual write pointer 340 catching the virtual read pointer 335. At this period in time, the HDMI source transport layer circuitry 320 stops (e.g., pauses) transmission of FRL characters over the FRL interface 110. Stopping (e.g., pausing) FRL character transmission allows the virtual read pointer 335 to increment away from the virtual write pointer 340 over one or more clock periods due to the DDA 330 continuing to increment the virtual read pointer 335 while the virtual write pointer 340 remains static. This operation results in a third example configuration 515 of the virtual source buffer 325 in which the virtual read pointer 335 has incremented away from the virtual write pointer 340. Such incrementing continues until the virtual source buffer 325 is in an example fourth configuration 520 in which the virtual read pointer 335 catches up to the virtual write pointer 340, which causes the HDMI source transport layer circuitry 320 to start (e.g., resume) transmission of FRL characters over the FRL interface 110.

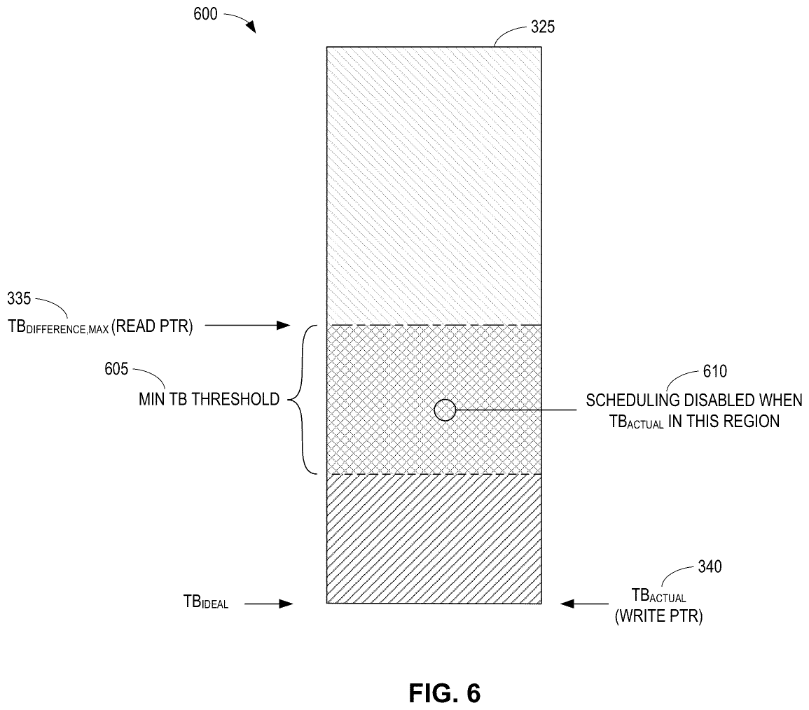

In addition to using the virtual source buffer 325 for resource checks, thresholds (e.g., which may be fixed or programmable) may be used by the HDMI source transport layer circuitry 320 to cause the scheduler circuitry 360 to wait for the virtual read pointer 335 and the virtual write pointer 340 to have a particular separation before new FRL characters are dispatched to the FRL interface 110. FIG. 6 illustrates an example configuration 600 of the virtual source buffer 325 using an example threshold 605 to define an example region 610 of the virtual source buffer 325 in which scheduling is paused until the virtual read pointer 335 and the virtual write pointer 340 are separated by the threshold amount.

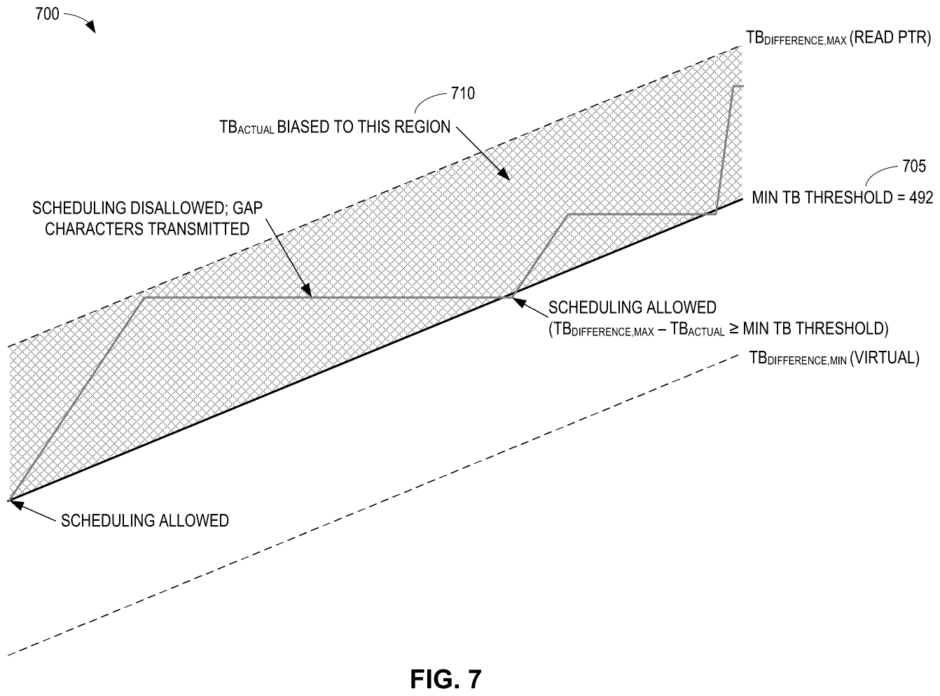

FIG. 7 illustrates an example configuration 700 of the virtual source buffer 325 using an example threshold 705 to support a non-borrowing scenario. In the example configuration 700, the threshold 705 biases the virtual write pointer 340 to an example region 710 of the virtual source buffer 325 between the TB_{Difference,Max} value and the threshold 705.

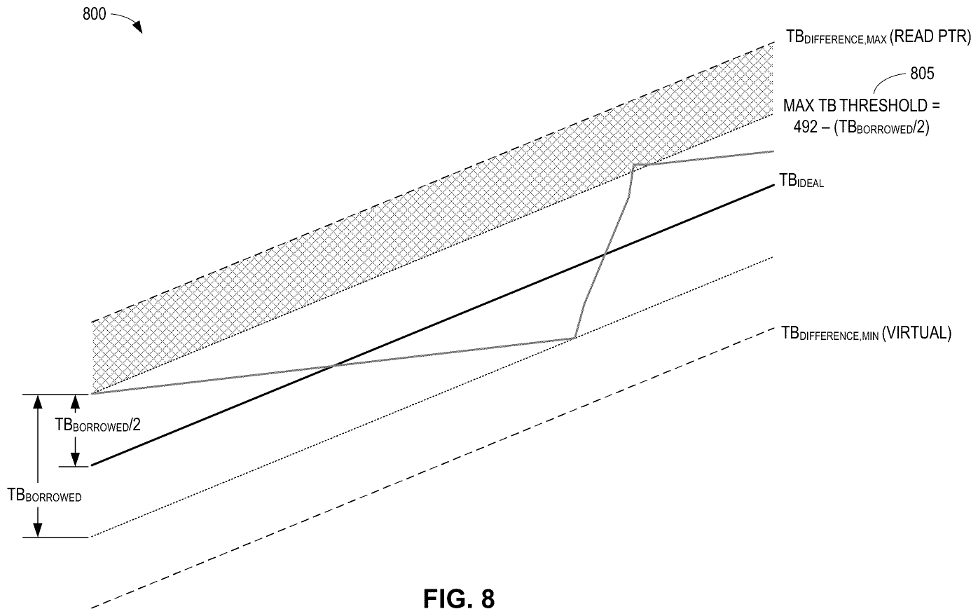

FIG. 8 illustrates an example configuration 800 of the virtual source buffer 325 using an example threshold 805 to support a borrowing scenario. In the example configuration 800, the threshold 805 is set to an upper TB_{Borrowed} range, which allows the active video FRL characters to be transmitted contiguously without gap characters.

Returning to FIG. 3, the HDMI source transport layer circuitry 320 also includes the FRL overhead circuitry 165 and the physical interface circuitry 170 of the source device 105. Accordingly, the descriptions of the FRL overhead circuitry 165 and the physical interface circuitry 170 are provided above in the context of the description of FIG. 1 and are not reproduced in the description of FIG. 3.

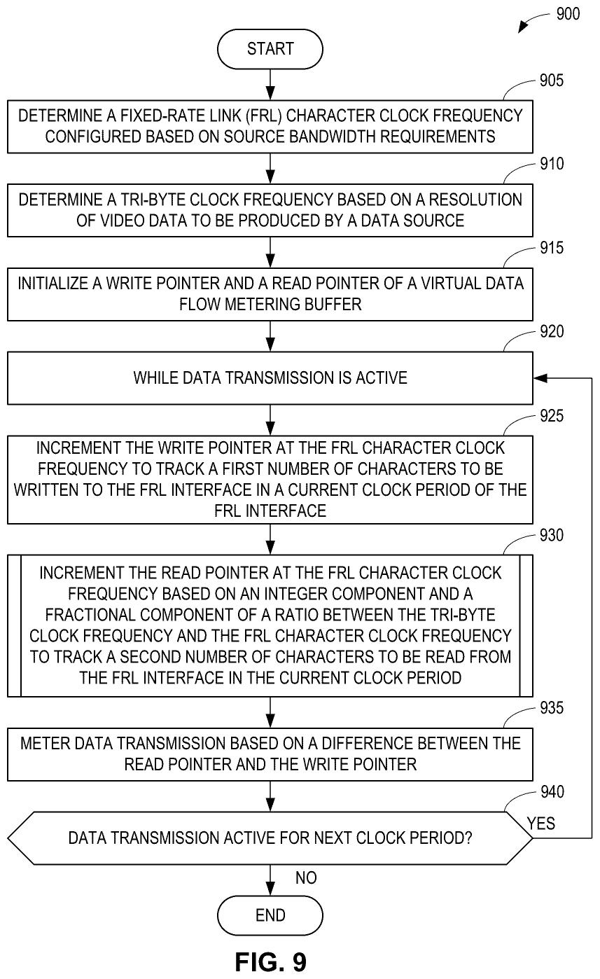

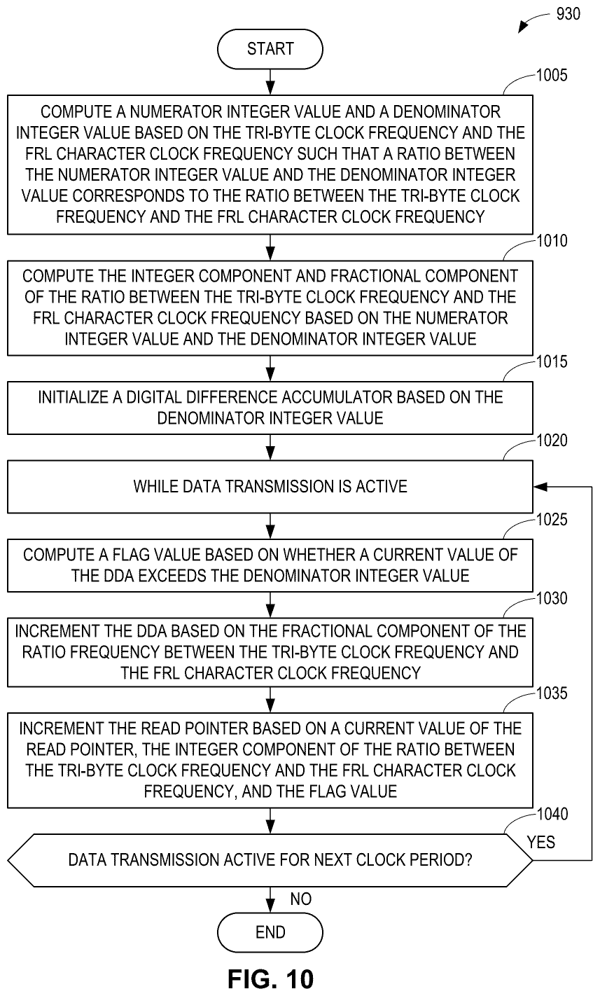

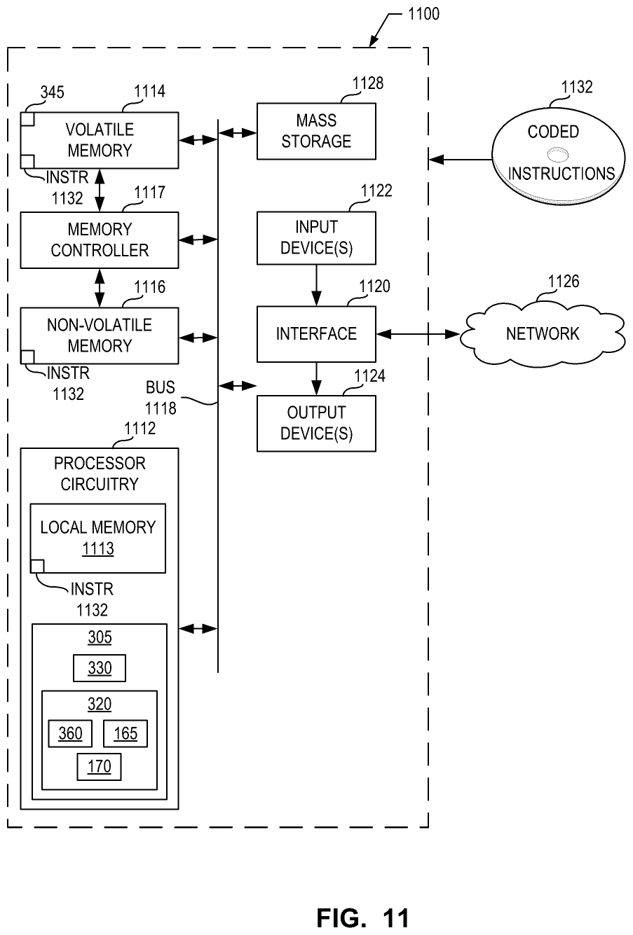

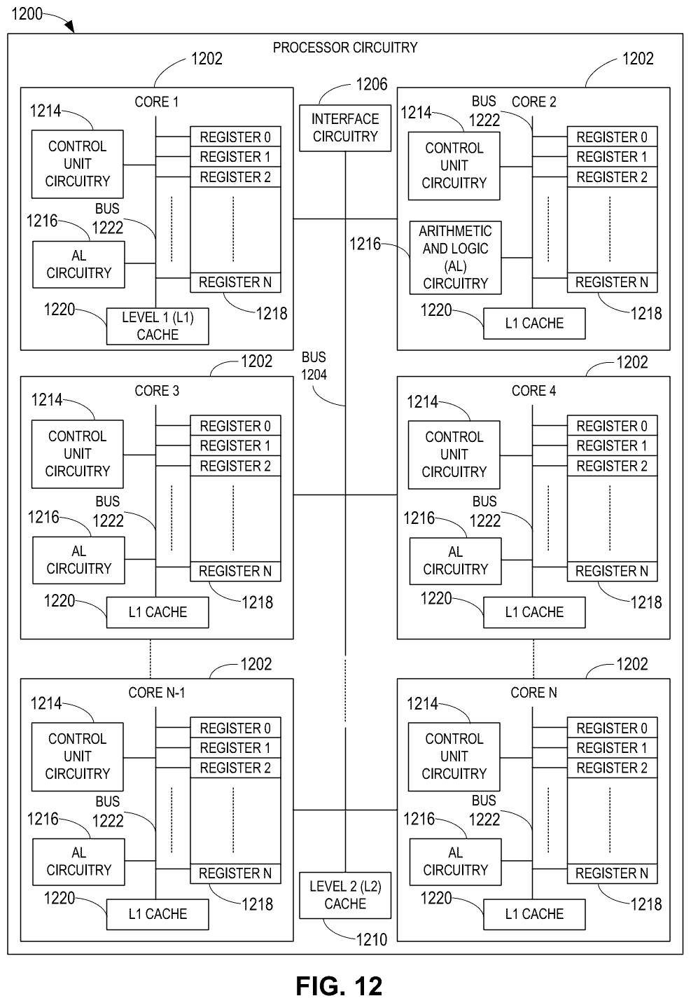

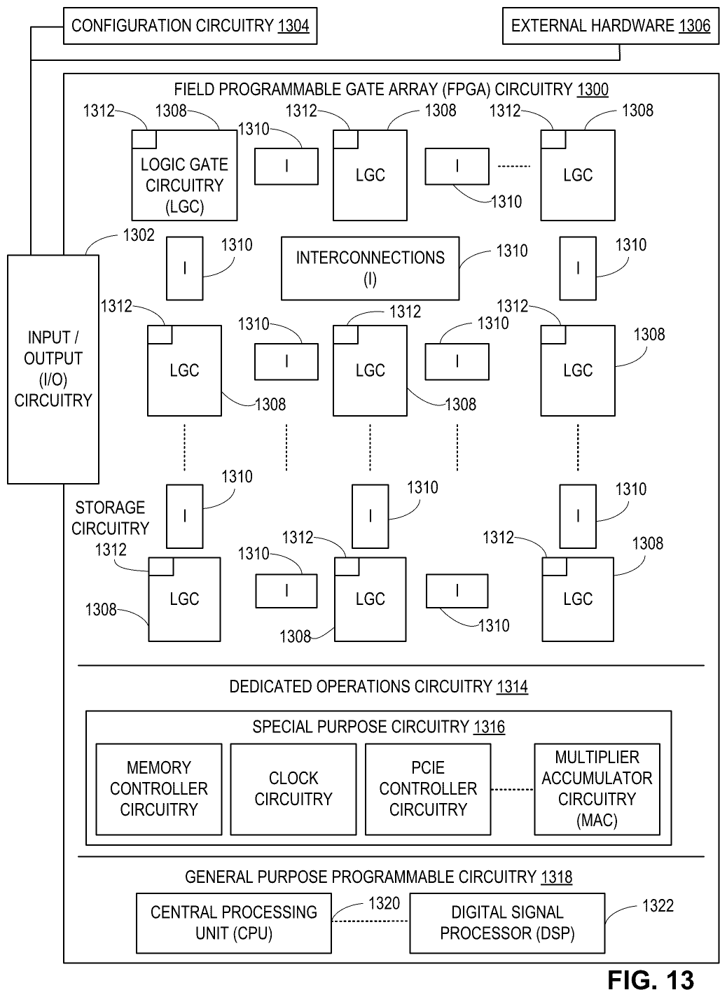

In some examples, the source device 305 includes means for performing data flow metering. For example, the means for performing data flow metering may be implemented by the HDMI source transport layer circuitry 320. In some examples, the HDMI source transport layer circuitry 320 may be instantiated by programmable circuitry such as the example programmable circuitry 1112 of FIG. 11. For instance, the HDMI source transport layer circuitry 320 may be instantiated by the example microprocessor 1200 of FIG. 12 executing machine executable instructions such as those implemented by at least blocks 905-940 of FIG. 9, and/or blocks 1005-1015 and 1035 of FIG. 10. In some examples, the HDMI source transport layer circuitry 320 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the HDMI source transport layer circuitry 320 may be instantiated by any other combination of hardware, software, and/or firmware. For example, the HDMI source transport layer circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the source device 305 includes means for accumulating values to increment virtual pointers of a virtual buffer. For example, the means for accumulating values may be implemented by the DDA 330. In some examples, the DDA 330 may be instantiated by programmable circuitry such as the example programmable circuitry 1112 of FIG. 11. For instance, the DDA 330 may be instantiated by the example microprocessor 1200 of FIG. 12 executing machine executable instructions such as those implemented by at least blocks 1025-1030 of FIG. 10. In some examples, the DDA 330 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the DDA 330 may be instantiated by any other combination of hardware, software, and/or firmware. For example, the DDA 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the source device 305 includes means for writing data to an FRL interface. For example, the means for writing data may be implemented by the physical interface circuitry 170. In some examples, the physical interface circuitry 170 may be instantiated by programmable circuitry such as the example programmable circuitry 1112 of FIG. 11. For instance, the physical interface circuitry 170 may be instantiated by the example microprocessor 1200 of FIG. 12 executing machine executable instructions such as those implemented by at least block 935 of FIG. 9. In some examples, the physical interface circuitry 170 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the physical interface circuitry 170 may be instantiated by any other combination of hardware, software, and/or firmware. For example, the physical interface circuitry 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the source device 305 is illustrated in FIG. 3, one or more of the elements, processes, and/or devices illustrated in FIG. 3 may be combined, divided, re-arranged, omitted, eliminated, and/or implemented in any other way. Further, the example HDMI source transport layer circuitry 320, the example DDA 330, the example scheduler circuitry 360, the example FRL overhead circuitry 165, the example physical interface circuitry 170, and/or, more generally, the example source device 305 of FIG. 3, may be implemented by hardware alone or by hardware in combination with software and/or firmware. Thus, for example, any of the example HDMI source transport layer circuitry 320, the example DDA 330, the example scheduler circuitry 360, the example FRL overhead circuitry 165, the example physical interface circuitry 170, and/or, more generally, the example source device 305, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example source device 305 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the source device 305 of FIG. 3 and/or representative of example operations which may be performed by programmable circuitry to implement and/or instantiate the source device 305 of FIG. 3, are shown in FIGS. 9-10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-10, many other methods of implementing the example source device 305 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUS, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to perform data flow metering in the example source device 305 of FIG. 3. The example machine-readable instructions and/or the example operations 900 of FIG. 9 begin at block 905, at which the HDMI source transport layer circuitry 320 of the source device 305 determines an FRL character clock frequency (e.g., f_{FRL Char clock}) configured for the FRL interface 110. At block 910, the HDMI source transport layer circuitry 320 determines a tri-byte clock frequency (e.g., f_{TB,Average}) based on the resolution of the video data to be produced by the source device 305 for transmission to the sink device 115. At block 915, the HDMI source transport layer circuitry 320 initializes the virtual read pointer 335 and the virtual write pointer 340 of the virtual source buffer 325, as described above.

Next, while active video data is being generated for transmission (block 920), operation proceeds to block 925. At block 925, the HDMI source transport layer circuitry 320 increments, as described above, the virtual write pointer 340 of the virtual source buffer 325 at the FRL character clock frequency (e.g., f_{FRL Char clock}) to track a first number of FRL characters to be written to the FRL interface 110 in a current clock period of the FRL interface 110. At block 930, the HDMI source transport layer circuitry 320 increments the virtual read pointer 335 of the virtual source buffer 325 at the FRL character clock frequency (e.g., f_{FRL Char clock}) based on an integer component (e.g., TB_{ideal} Ratio_{integer}) and a fractional component (TB_{ideal} Ratio_{fraction}) of a ratio (e.g., TB_{ideal} M/N) between the tri-byte clock frequency (e.g., f_{TB,Average}) and the FRL character clock frequency (e.g., f_{FRL Char clock}) to track a second number of FRL characters to be read from the FRL interface 110 in the current clock period. Example machine-readable instructions and/or operations that may be used to implement the processing at block 930 are illustrated in FIG. 10, which is described in detail below.

At block 935, the HDMI source transport layer circuitry 320 and the physical interface circuitry 170 of the source device 305 meter data transmission over the FRL interface 110 based on a difference between the virtual read pointer 335 and the virtual write pointer 340 of the virtual source buffer 325, as described above. At block 940, processing continues to iterate over blocks 920 to 940 while active video is being generated for transmission during a next clock period. When the source device 305 stops generating active video, the example machine-readable instructions and/or the example operations 900 of FIG. 9 end.

FIG. 10 is a flowchart representative of example machine readable instructions and/or example operations 930 that may be executed, instantiated, and/or performed by programmable circuitry to increment the virtual read pointer 335 used to perform data flow metering in the example source device 305 of FIG. 3. The example machine-readable instructions and/or the example operations 930 of FIG. 10 begin at block 1005, at which the HDMI source transport layer circuitry 320 of the source device 305 computes a numerator integer value (TB_{ideal} M) and a denominator integer value (TB_{ideal} N) based on the tri-byte clock frequency (e.g., f_{TB,Average}) and the FRL character clock frequency (e.g., f_{FRL Char clock}) such that a ratio between the numerator integer value (e.g., TB_{ideal} M) and the denominator integer value (e.g., TB_{ideal} N) corresponds to the ratio (e.g., TB_{ideal} M/N) between the tri-byte clock frequency (e.g., f_{TB,Average}) and the FRL character clock frequency (e.g., f_{FRL Char clock}), as described above (e.g., using Equation 4). At block 1010, the HDMI source transport layer circuitry 320 computes the integer component (e.g., TB_{ideal} Ratio_{integer}) and fractional component (e.g., TB_{ideal} Ratio_{fraction}) of the ratio (e.g., TB_{ideal} M/N) between the tri-byte clock frequency (e.g., f_{TB,Average}) and the FRL character clock frequency (e.g., f_{FRL Char clock}) based on the numerator integer value (e.g., TB_{ideal} M) and the denominator integer value (e.g., TB_{ideal} N), as described above (e.g., using Equation 5). At block 1015, the HDMI source transport layer circuitry 320 initializes the DDA 330 of the source device 305 based on the denominator integer value (e.g., TB_{ideal} N), as described above (e.g., using Equation 6).

Next, while source data (e.g., active video data and/or blanking data) is being generated for transmission (block 1020), operation proceeds to block 1025. At block 1025, the DDA 330 computes a flag value (e.g., DDA Trip) based on whether the current value of the DDA 330 (e.g., Current TB_{ideal} DDA) exceeds the denominator integer value (e.g., TB_{ideal} N), as described above (e.g., using Table 2). At block 1030, the DDA 330 increments based on the fractional component (e.g., TB_{ideal} Ratio_{fraction}) of the ratio (e.g., TB_{ideal} M/N) between the tri-byte clock frequency (e.g., f_{TB,Average}) and the FRL character clock frequency (e.g., f_{FRL Char clock}), as described above (e.g., using Table 2). At block 1035, the HDMI source transport layer circuitry 320 increments the virtual read pointer 335 based on a current value of the read pointer 335, the integer component (e.g., TB_{ideal} Ratio_{integer}) of the ratio (e.g., TB_{ideal} M/N) between the tri-byte clock frequency (e.g., f_{TB,Average}) and the FRL character clock frequency (e.g., f_{FRL Char clock}), and the flag value (e.g., DDA Trip), as described above (e.g., using Equation 7).

At block 1040, processing continues to iterate over blocks 1020 to 1040 while active video is being generated for transmission during a next clock period. When the source device 305 stops generating active video, the example machine-readable instructions and/or the example operations 1000 of FIG. 10 end.

FIG. 11 is a block diagram of an example programmable circuitry platform 1100 structured to execute and/or instantiate the example machine-readable instructions and/or the example operations of FIGS. 9-10 to implement the source device 305 of FIG. 3. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, VPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example HDMI source transport layer circuitry 320, the example DDA 330, the example scheduler circuitry 360, the example FRL overhead circuitry 165, the example physical interface circuitry 170, and/or, more generally, the example source device 305.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 9-10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 9-10 to effectively instantiate the circuitry of FIG. 3 as logic circuits to perform operations corresponding to those machine readable instructions. In some such examples, the circuitry of FIG. 3 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 9-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 9-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-10. As such, the FPGA circuitry 1300 may be configured and/or structured to effectively instantiate some or all of the operations/functions corresponding to the machine readable instructions of the flowchart(s) of FIGS. 9-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 9-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 9-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 9-10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 9-10, and/or an ASIC may be configured and/or structured to perform third operation(s)/function(s) corresponding to a third portion of the machine readable instructions represented by the flowcharts of FIGS. 9-10.

It should be understood that some or all of the circuitry of FIG. 3 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 3 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

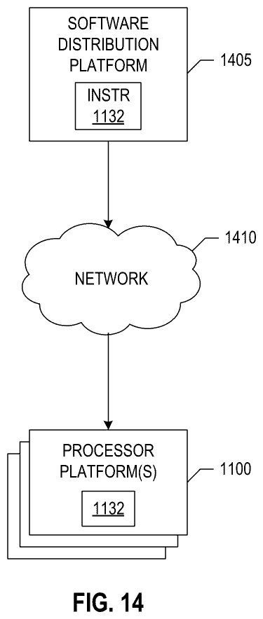

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 9-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 9-10, may be downloaded to the example programmable circuitry platform 1100, which is to execute the machine readable instructions 1132 to implement the source device 305. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement data flow metering (DFM) on a fixed rate link (FRL) interface. Disclosed systems, apparatus, articles of manufacture, and methods improve the efficiency of using a computing device by implementing DFM on an FRL interface without a physical clock crossing buffer, and without a second PLL to track both the pixel clock domain in which video data is generated and the FRL clock domain in which data is transmitted over the FRL interface. As such, disclosed systems, apparatus, articles of manufacture, and methods can be used to reduce the circuitry, power consumption, size, etc., of compute devices that communicate over FRL interfaces. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry to write characters to a fixed rate link interface, machine-readable instructions, and at least one programmable circuit to be programmed based on the machine-readable instructions to increment a first pointer to track a first number of data characters to be written to the fixed rate link interface in a clock period of the fixed rate link interface, the fixed rate link interface associated with a first clock frequency, increment a second pointer to track a second number of data characters to be read from the fixed rate link interface in the clock period, the second pointer incremented based on an integer component and a fractional component of a ratio between a second clock frequency and the first clock frequency, the second clock frequency associated with a data source, and meter data transmission on the fixed rate link interface based on a difference between the second pointer and the first pointer.

Example 2 includes the apparatus of example 1, wherein the fixed rate link interface is compliant with a high-definition multimedia interface (HDMI)® specification, the data source is to generate video data associated with a first video resolution, and the second clock frequency corresponds to a tri-byte rate associated with the first video resolution.

Example 3 includes the apparatus of example 1 or example 2, wherein one or more of the at least one programmable circuit is to increment the first pointer at the first clock frequency and increment the second pointer at the first clock frequency.

Example 4 includes the apparatus of any one of examples 1 to 3, wherein one or more of the at least one programmable circuit is to increment the second pointer based on a current value of the second pointer, the integer component of the ratio, and a flag value, the flag value based on a digital difference accumulator (DDA).

Example 5 includes the apparatus of example 4, wherein one or more of the at least one programmable circuit is to at least one of configure or implement the DDA to increment at the first clock frequency.

Example 6 includes the apparatus of example 4 or example 5, wherein the ratio is a first ratio, and one or more of the at least one programmable circuit is to compute a first integer value and a second integer value based on the first clock frequency and the second clock frequency, a second ratio between the second integer value and the first integer value to correspond to the first ratio, set the flag value based on whether a current value of the DDA exceeds the first integer value, and cause the DDA to increment by an amount based on the fractional component of the first ratio.

Example 7 includes the apparatus of example 6, wherein one or more of the at least one programmable circuit is to one of, based on the current value of the DDA exceeding the first integer value, set the flag value to a first binary value, and cause the DDA to adjust by a difference between the fractional component of the first ratio and the first integer value, or, based on the current value of the DDA not exceeding the first integer value, set the flag value to a second binary value, and cause the DDA to adjust by the fractional component of the first ratio.

Example 8 includes the apparatus of example 6 or example 7, wherein one or more of the at least one programmable circuit is to initialize the DDA based on the first integer value.

Example 9 includes the apparatus of any one of examples 4 to 8, wherein one or more of the at least one programmable circuit is to set the second pointer based on a sum of the current value of the second pointer, the integer component of the ratio, and the flag value.

Example 10 includes the apparatus of any one of examples 1 to 9, wherein one or more of the at least one programmable circuit is to convert, based on a type of traffic to be transmitted on the fixed rate link interface, the difference between the second pointer and the first pointer into a third number of characters available for transmission on the fixed rate link interface.

Example 11 includes the apparatus of any one of examples 1 to 10, wherein one or more of the at least one programmable circuit is to meter data transmission on the fixed rate link interface based on the difference between the second pointer and the first pointer, and a threshold.

Example 12 includes the apparatus of example 11, wherein one or more of the at least one programmable circuit is to set the threshold based on whether bandwidth for transmission of blanking data on the fixed rate link interface is to be borrowed for transmission of video data on the fixed rate link interface.

Example 13 includes at least one non-transitory machine-readable medium comprising machine-readable instructions to cause at least one programmable circuit to at least adjust a first pointer to track a first number of data characters to be written to a fixed rate link interface in a clock period of the fixed rate link interface, the fixed rate link interface associated with a first clock frequency, adjust a second pointer to track a second number of data characters to be read from the fixed rate link interface in the clock period, the second pointer adjusted based on an integer component and a fractional component of a ratio between a second clock frequency and the first clock frequency, the second clock frequency associated with a source of the data characters, and regulate data transmission on the fixed rate link interface based on the first pointer and the second pointer.

Example 14 includes the at least one non-transitory machine-readable medium of example 13, wherein the machine-readable instructions are to cause one or more of the at least one programmable circuit to adjust the second pointer based on a current value of the second pointer, the integer component of the ratio, and a flag value, the flag value based on an accumulator value.

Example 15 includes the at least one non-transitory machine-readable medium of example 14, wherein the ratio is a first ratio, and the machine-readable instructions are to cause one or more of the at least one programmable circuit to compute a first integer value and a second integer value based on the first clock frequency and the second clock frequency, a second ratio between the second integer value and the first integer value to correspond to the first ratio, set the flag value based on whether the accumulator value exceeds the first integer value, the accumulator value initialized based on the first integer value, and adjust the accumulator value by an amount based on the fractional component of the first ratio.

Example 16 includes the at least one non-transitory machine-readable medium of example 15, wherein the machine-readable instructions are to cause one or more of the at least one programmable circuit to, based on the accumulator value exceeding the first integer value, set the flag value to a first binary value, and adjust the accumulator value by a difference between the fractional component of the first ratio and the first integer value, or, based on the accumulator value not exceeding the first integer value, set the flag value to a second binary value, and adjust the accumulator value by the fractional component of the first ratio.

Example 17 includes a system comprising means for writing characters to a fixed rate link interface, and means for metering data transmission on the fixed rate link interface, the means for metering data transmission to increment a first pointer at a first clock frequency to track a first number of data characters to be written to the fixed rate link interface in a clock period of the fixed rate link interface, the fixed rate link interface associated with the first clock frequency, increment a second pointer at the first clock frequency to track a second number of data characters to be read from the fixed rate link interface in the clock period, the second pointer incremented based on an integer component and a fractional component of a ratio between a second clock frequency and the first clock frequency, the second clock frequency associated with a data source, and meter transmission of data on the fixed rate link interface based on the first pointer and the second pointer.

Example 18 includes the system of example 17, wherein the means for metering data transmission is to increment the second pointer based on a current value of the second pointer, the integer component of the ratio, and a flag value, the flag value based on an accumulator value.

Example 19 includes the system of example 18, wherein the ratio is a first ratio, and including means for accumulating values, wherein the means for metering data transmission is to compute a first integer value and a second integer value based on the first clock frequency and the second clock frequency, a second ratio between the second integer value and the first integer value to correspond to the first ratio, and set the flag value based on whether the accumulator value exceeds the first integer value, the accumulator value initialized based on the first integer value, and the means for accumulating values is to increment the accumulator value by an amount based on the fractional component of the first ratio.

Example 20 includes the method of example 19, wherein the means for metering data transmission is to set the flag value to a first binary value and the means for accumulating values is to increment the accumulator value by a difference between the fractional component of the first ratio and the first integer value based on the accumulator value exceeding the first integer value, and the means for metering data transmission is to set the flag value to a second binary value and the means for accumulating values is to increment the accumulator value by the fractional component of the first ratio based on the accumulator value not exceeding the first integer value.

Example 21 includes a method comprising incrementing a first pointer at a first clock frequency to track a first number of data characters to be written to a fixed rate link interface in a clock period of the fixed rate link interface, the fixed rate link interface associated with the first clock frequency, incrementing, by at least one programmable circuit based on at least one machine-readable instruction, a second pointer at the first clock frequency to track a second number of data characters to be read from the fixed rate link interface in the clock period, the second pointer incremented based on an integer component and a fractional component of a ratio between a second clock frequency and the first clock frequency, the second clock frequency associated with a data source, and metering data transmission on the fixed rate link interface based on the first pointer and the second pointer.

Example 22 includes the method of example 21, wherein the fixed rate link interface is compliant with a high-definition multimedia interface (HDMI)® specification, the data source is to generate video data associated with a first video resolution, and the second clock frequency corresponds to a tri-byte rate associated with the first video resolution.

Example 23 includes the method of example 21 or example 22, wherein the incrementing of the first pointer is at the first clock frequency and the incrementing of the second pointer is at the first clock frequency.

Example 24 includes the method any one of examples 21 to 23, wherein the incrementing of the second pointer is based on a current value of the second pointer, the integer component of the ratio, and a flag value, the flag value based on an accumulator value.

Example 25 includes the method of example 24, wherein the ratio is a first ratio, and including computing a first integer value and a second integer value based on the first clock frequency and the second clock frequency, a second ratio between the second integer value and the first integer value to correspond to the first ratio, setting the flag value based on whether the accumulator value exceeds the first integer value, the accumulator value initialized based on the first integer value, and incrementing the accumulator value by an amount based on the fractional component of the first ratio.

Example 26 includes the method of example 25, wherein the setting of the flag value and the incrementing of the accumulator value include, based on the accumulator value exceeding the first integer value, setting the flag value to a first binary value, and incrementing the accumulator value by a difference between the fractional component of the first ratio and the first integer value, or, based on the accumulator value not exceeding the first integer value, setting the flag value to a second binary value, and incrementing the accumulator value by the fractional component of the first ratio.

Example 27 includes the method of example 25 or example 26, including initializing the accumulator value based on the first integer value.

Example 28 includes the method any one of examples 25 to 27, wherein the incrementing of the second pointer is based on a sum of the current value of the second pointer, the integer component of the ratio, and the flag value.

Example 29 includes the method of any one of examples 21 to 28, including converting, based on a type of traffic to be transmitted on the fixed rate link interface, the difference between the second pointer and the first pointer into a third number of characters available for transmission on the fixed rate link interface.

Example 30 includes the method of any one of examples 21 to 29, the metering of the data transmission on the fixed rate link interface is based on the difference between the second pointer and the first pointer, and a threshold.

Example 31 includes the method of example 30, including setting the threshold based on whether bandwidth for transmission of blanking data on the fixed rate link interface is to be borrowed for transmission of video data on the fixed rate link interface.

Example 32 includes at least one machine-readable medium comprising machine-readable instructions to cause at least one programmable circuit to perform the method of any one of examples 21 to 31.

Example 33 includes an apparatus to perform the method of any one of examples 21 to 31.

Example 34 includes a method performed by any one of the apparatus of examples 1 to 12.

Example 35 includes at least one machine-readable medium comprising the machine-readable instructions of any one of the apparatus of examples 1 to 12.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to write characters to a fixed rate link interface;
machine-readable instructions; and
at least one programmable circuit to be programmed based on the machine-readable instructions to:
increment a first pointer to track a first number of data characters to be written to the fixed rate link interface in a clock period of the fixed rate link interface, the fixed rate link interface associated with a first clock frequency;
increment a second pointer to track a second number of data characters to be read from the fixed rate link interface in the clock period, the second pointer incremented based on an integer component and a fractional component of a ratio between a second clock frequency and the first clock frequency, the second clock frequency associated with a data source; and
meter data transmission on the fixed rate link interface based on a difference between the second pointer and the first pointer.

2. The apparatus of claim 1, wherein the fixed rate link interface is compliant with a high-definition multimedia interface (HDMI)® specification, the data source is to generate video data associated with a first video resolution, and the second clock frequency corresponds to a tri-byte rate associated with the first video resolution.

3. The apparatus of claim 1, wherein one or more of the at least one programmable circuit is to increment the first pointer at the first clock frequency and increment the second pointer at the first clock frequency.

4. The apparatus of claim 1, wherein one or more of the at least one programmable circuit is to increment the second pointer based on a current value of the second pointer, the integer component of the ratio, and a flag value, the flag value based on a digital difference accumulator (DDA).

5. The apparatus of claim 4, wherein one or more of the at least one programmable circuit is to at least one of configure or implement the DDA to increment at the first clock frequency.

6. The apparatus of claim 4, wherein the ratio is a first ratio, and one or more of the at least one programmable circuit is to:
compute a first integer value and a second integer value based on the first clock frequency and the second clock frequency, a second ratio between the second integer value and the first integer value to correspond to the first ratio;
set the flag value based on whether a current value of the DDA exceeds the first integer value; and
cause the DDA to increment by an amount based on the fractional component of the first ratio.

7. The apparatus of claim 6, wherein one or more of the at least one programmable circuit is to one of:
based on the current value of the DDA exceeding the first integer value:
set the flag value to a first binary value; and
cause the DDA to adjust by a difference between the fractional component of the first ratio and the first integer value; or
based on the current value of the DDA not exceeding the first integer value:
set the flag value to a second binary value; and
cause the DDA to adjust by the fractional component of the first ratio.

8. The apparatus of claim 6, wherein one or more of the at least one programmable circuit is to initialize the DDA based on the first integer value.

9. The apparatus of claim 4, wherein one or more of the at least one programmable circuit is to set the second pointer based on a sum of the current value of the second pointer, the integer component of the ratio, and the flag value.

10. The apparatus of claim 1, wherein one or more of the at least one programmable circuit is to convert, based on a type of traffic to be transmitted on the fixed rate link interface, the difference between the second pointer and the first pointer into a third number of characters available for transmission on the fixed rate link interface.

11. The apparatus of claim 1, wherein one or more of the at least one programmable circuit is to meter data transmission on the fixed rate link interface based on the difference between the second pointer and the first pointer, and a threshold.

12. The apparatus of claim 11, wherein one or more of the at least one programmable circuit is to set the threshold based on whether bandwidth for transmission of blanking data on the fixed rate link interface is to be borrowed for transmission of video data on the fixed rate link interface.

13. At least one non-transitory machine-readable medium comprising machine-readable instructions to cause at least one programmable circuit to at least:
adjust a first pointer to track a first number of data characters to be written to a fixed rate link interface in a clock period of the fixed rate link interface, the fixed rate link interface associated with a first clock frequency;
adjust a second pointer to track a second number of data characters to be read from the fixed rate link interface in the clock period, the second pointer adjusted based on an integer component and a fractional component of a ratio between a second clock frequency and the first clock frequency, the second clock frequency associated with a source of the data characters; and
regulate data transmission on the fixed rate link interface based on the first pointer and the second pointer.

14. The at least one non-transitory machine-readable medium of claim 13, wherein the machine-readable instructions are to cause one or more of the at least one programmable circuit to adjust the second pointer based on a current value of the second pointer, the integer component of the ratio, and a flag value, the flag value based on an accumulator value.

15. The at least one non-transitory machine-readable medium of claim 14, wherein the ratio is a first ratio, and the machine-readable instructions are to cause one or more of the at least one programmable circuit to:
compute a first integer value and a second integer value based on the first clock frequency and the second clock frequency, a second ratio between the second integer value and the first integer value to correspond to the first ratio;
set the flag value based on whether the accumulator value exceeds the first integer value, the accumulator value initialized based on the first integer value; and
adjust the accumulator value by an amount based on the fractional component of the first ratio.

16. The at least one non-transitory machine-readable medium of claim 15, wherein the machine-readable instructions are to cause one or more of the at least one programmable circuit to:
based on the accumulator value exceeding the first integer value:
set the flag value to a first binary value; and
adjust the accumulator value by a difference between the fractional component of the first ratio and the first integer value; or
based on the accumulator value not exceeding the first integer value:
set the flag value to a second binary value; and
adjust the accumulator value by the fractional component of the first ratio.

17. A system comprising:
means for writing characters to a fixed rate link interface; and
means for metering data transmission on the fixed rate link interface, the means for metering data transmission to:
increment a first pointer at a first clock frequency to track a first number of data characters to be written to the fixed rate link interface in a clock period of the fixed rate link interface, the fixed rate link interface associated with the first clock frequency;
increment a second pointer at the first clock frequency to track a second number of data characters to be read from the fixed rate link interface in the clock period, the second pointer incremented based on an integer component and a fractional component of a ratio between a second clock frequency and the first clock frequency, the second clock frequency associated with a data source; and
meter data transmission on the fixed rate link interface based on the first pointer and the second pointer.

18. The system of claim 17, wherein the means for metering data transmission is to increment the second pointer based on a current value of the second pointer, the integer component of the ratio, and a flag value, the flag value based on an accumulator value.

19. The system of claim 18, wherein the ratio is a first ratio, and including means for accumulating values, wherein:
the means for metering data transmission is to:
compute a first integer value and a second integer value based on the first clock frequency and the second clock frequency, a second ratio between the second integer value and the first integer value to correspond to the first ratio; and
set the flag value based on whether the accumulator value exceeds the first integer value, the accumulator value initialized based on the first integer value; and
the means for accumulating values is to increment the accumulator value by an amount based on the fractional component of the first ratio.

20. The system of claim 19, wherein:
the means for metering data transmission is to set the flag value to a first binary value and the means for accumulating values is to increment the accumulator value by a difference between the fractional component of the first ratio and the first integer value based on the accumulator value exceeding the first integer value; and
the means for metering data transmission is to set the flag value to a second binary value and the means for accumulating values is to increment the accumulator value by the fractional component of the first ratio based on the accumulator value not exceeding the first integer value.
